(19) United States
(12) Patent Application Publication
(10) Pub. No.: US 2011/0099517 A1
(43) Pub. Date: Apr. 28, 2011

(54) PRODUCT OPTION PRESENTATION IN A PRODUCT SELECTION AND MANAGEMENT WORKFLOW

(76) Inventors: Russell Mull, Corvallis, OR (US); Phil Manijak, Corvallis, OR (US); Marc Frederick Ayotte, Corvallis, OR (US); Michael R. Wilson, Corvallis, OR (US)

(21) Appl. No.: 12/607,766

(22) Filed: Oct. 28, 2009

(51) Int. Cl. G06F 3/048

(52) U.S. Cl. 715/810

(57) ABSTRACT

A product option selection method for a plurality of products populated with a selected plurality of digital images includes causing a display of a first option selector and a second option selector. The first option selector corresponds to an additional product related to one or more of the plurality of products, while the second option selector corresponds to a product option for an individual one of the plurality of products. Options are applied to the plurality of products according to a user's manipulation of the first and second option selectors.

### BACKGROUND

Consumers order single and multi-image products via kiosks and web services. Single image products include image prints of various sizes. Multi-image products include collage posters, photo books, and the like. Embodiments discussed below allow a user to select and manage multiple single and multi-image products within a single workflow. The user can select the same digital image to populate multiple products. For example, a user may select utilize a digital image to produce single image prints of various sizes. The user may also select that same digital image in a collage poser, a photo book, and a calendar. Once selected, a user may desire to add options to the selected products. Some options such as index prints and photo CDs apply to multiple selected products. Other options such as covers for photo books and frames for posters apply to individual products. With the new ability to select and manage multiple products in a single workflow, a problem arises in how to present the user with options for the various selected products.

### DRAWINGS

FIGS. 1 and 2 depict exemplary environments in which embodiments may be implemented.

FIGS. 3-12 depict exemplary screen views of a user interface according to embodiments.

FIG. 13 depicts an exemplary product preview system according to an embodiment.

FIGS. 14-15 are block diagrams of environments in which the system of FIG. 13 may be implemented.

FIG. 16 is a flow diagram depicting steps take to implement an embodiment.

### DETAILED DESCRIPTION

Various embodiments described below operate to provide a common workflow for selecting and managing single and multi image products. Within that workflow, the user is presented with a single screen through which the user can choose from among all options available for a set of selected products selected. In particular, a list identifying a series of selected products is examined to identify options applicable to the identified products. In context of the following description, the term list refers to an electronic data identifying a product or set of products as selected an edited by a user. For an option applicable to multiple selected products, the user is presented with a single control for choosing that option. For an option applicable to individual products, the user is presented with a separate control for choosing that option for each product to which the option applies.

The following description is broken into sections. The first, labeled “Environment,” describes exemplary environments in which embodiments may be implemented. The second section, labeled “Workflow,” describes a series of exemplary screen views depicting a common workflow for selecting, editing, and previewing single and multi-image products. The third section, labeled as “Components”, describes physical and logical components of various embodiments. The last section, labeled “Operation,” describes steps taken to implement various embodiments.

### Environment

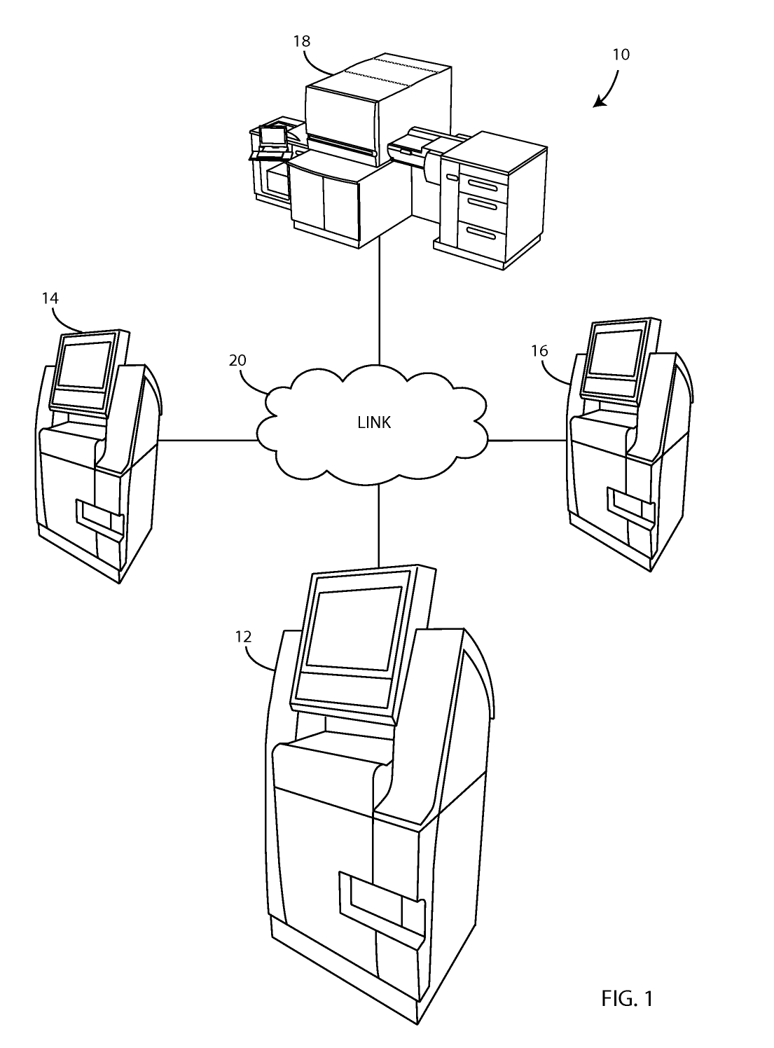

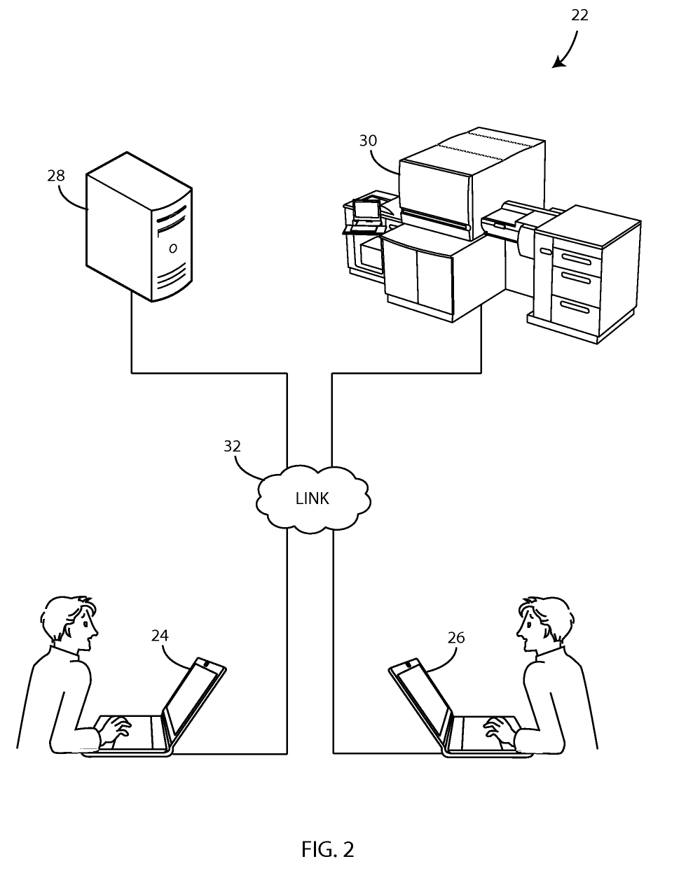

FIGS. 1-2 depict exemplary environments in which embodiments may be implemented. Starting with FIG. 1, environment 10 includes kiosks 12, 14, and 16 and production service 18 interconnected via link 20. Kiosks 12-16 each represent a computing device through which a user can select, edit, and order single and multi-image products. Each kiosk 12-16 presents a user interface via a display device. Often this display device incorporates a touch screen allowing the user to manipulate various controls with the touch or slide of a finger. Accessing digital images via a memory card or the internet, programming on each kiosk 12-16 allows a user to select from among the digital images, edit selected digital images, and order single and multi-image products populated with selected digital images.

Production service 18 represents generally any device or collection of devices capable of producing single and multi-image products ordered via kiosks 12-16. Link 20 represents generally one or more of a cable, wireless, fiber optic, or remote connection via a telecommunication link, an infrared link, a radio frequency link, or any other connector or system that provides electronic communication. Link 20 may represent an intranet, the Internet, or a combination of both. The paths followed by link 20 between kiosks 12-16 and production service 18 as depicted in FIG. 1 represent the logical communication paths between these devices, not necessarily the physical paths between the devices.

FIG. 2 depicts another environment 22 in which embodiments may be implemented. Environment 22 is shown to include client devices 24 and 26, server device 28, and production service 30 interconnected via link 32. Client devices 24 and 26 represent generally any computing devices capable of visually presenting a graphical user interface to a user and receiving user input via a touch screen, mouse, and/or a keyboard. Server device 28 represents generally any computing device capable of serving content to client devices 24, 26 that enable users to order single and multi-image products. Accessing digital images from client devices 24 or 26 or stored locally, server device 28 serves web pages or other content enabling users to select from among the digital images, edit selected digital images, and order single and multi-image products populated with selected digital images.

Production service 30 represents generally any device or collection of devices capable of producing single and multi-image products ordered via client devices 24, 26 and server device 28. Link 32 represents generally one or more of a cable, wireless, fiber optic, or remote connection via a telecommunication link, an infrared link, a radio frequency link, or any other connector or system that provides electronic communication. Link 32 may represent an intranet, the Internet, or a combination of both. The paths followed by link 32 between devices 24-30 as depicted in FIG. 2 represent the logical communication paths between these devices, not necessarily the physical paths between the devices.

### Workflow

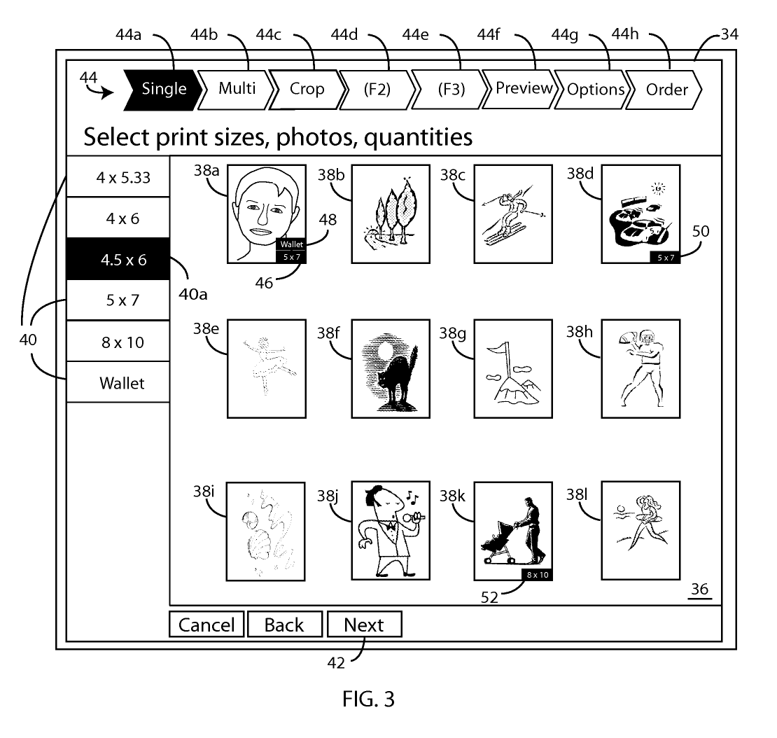

FIGS. 3-13 depict exemplary screen views of a user interface 34 through which a user can choose options for single and multi-image products selected via a common workflow. The term workflow as used herein refers to a defined series of tasks for producing a final outcome. From a user's perspective, initial tasks involve a user's selection from among various single and multi-image products as well as the user's selection of digital images for populating those products. A subsequent task can include editing each instance of a selected digital image used to populate a given product. Various selected products populated with selected and edited digital images can then be previewed and ultimately ordered. Ordering, for example, can include sending a job or jobs to a production service requesting the production of one or more user selected, populated, and edited products.

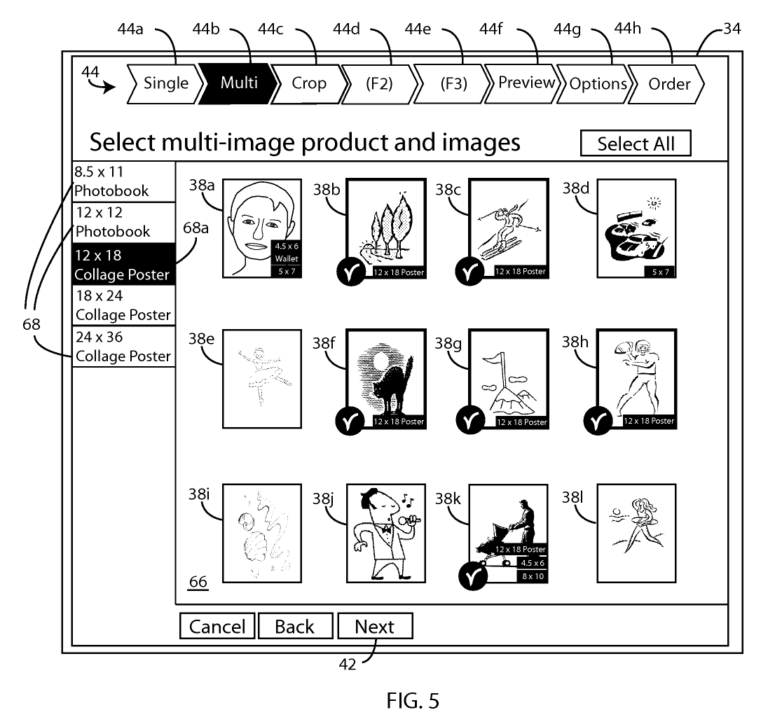

Starting with FIG. 3, user interface 34 is shown to include frame 36. The term frame as used refers to a defined area within user interface 34 for displaying text and graphics. As will be seen with respect to FIGS. 5-13, user interface 34 includes multiple frames. Some are displayed together at the same time while others are displayed sequentially as a user proceeds through the workflow. Displayed within frame 36 are thumbnails 38a-38l, referred to collectively as thumbnails 38. Each thumbnail 38 is a user selectable control providing a visual representation of a given digital image. In other words, a user selects a given digital image by selecting a corresponding thumbnail 38. Frame 36 is also shown to include product controls 40 for selecting from among a number of single image products.

User interface 34 includes workflow control 42 and workflow indicator 44. Workflow control 42 represents generally a user selectable control or controls enabling a user to sequence through various tasks of the workflow. Workflow indicator 44 represents a graphic or textual indication of an active task within the workflow. In the example of FIG. 3, task 44a is highlighted within task indicator 44. Task 44a involves the selection of print sizes, digital images, and quantities for single image products identified by product controls 40. Here a user has selected product control 40a corresponding to 4.5×6 prints. While no thumbnails 38 have been selected for 4.5×6 single image prints, thumbnail 38a has been modified with marking 46 and 48 to indicate that the user has previously selected the corresponding digital image to be used in producing a 5×7 single image print and wallet sized prints. Thumbnail 38d has been modified with marking 50 to indicate that the user has previously selected the corresponding digital image to be used in producing a 5×7 single image print. Finally, thumbnail 38k has been modified with marking 52 to indicate that the user has previously selected the corresponding digital image to be used in producing an 8×10 single image print.

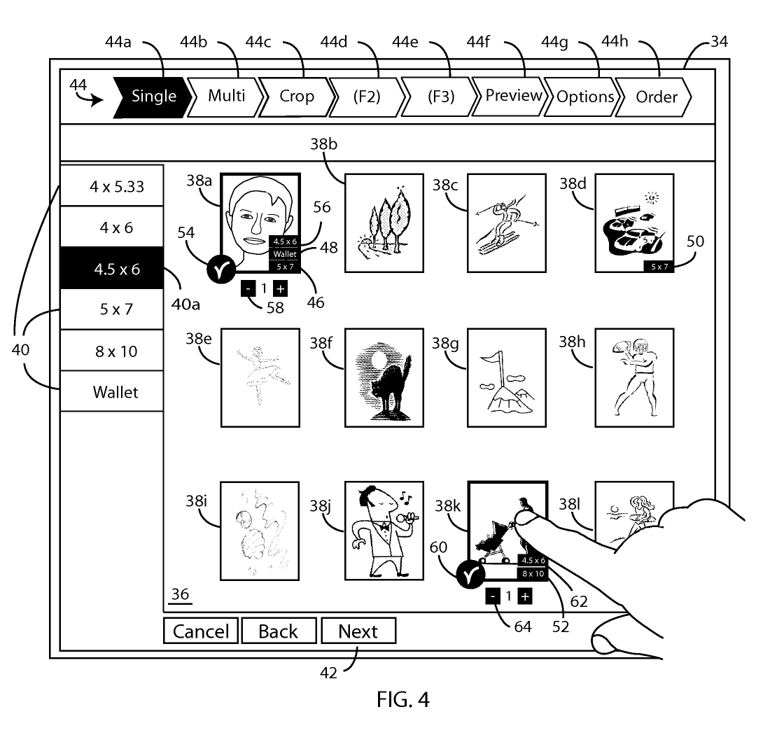

Moving to FIG. 4, the user has selected thumbnails 38a and 38k. As a result, thumbnail 38a has been modified with markings 54-58, and thumbnail 38d has been modified with markings 60-64. Markings 54 and 60 each provide an indication that a given thumbnail 38a and 38k has been selected with respect to currently selected product control 40a. Markings 56 and 62 indicate that the user has selected the corresponding digital images to be used in producing a 4.5×6 single image print. Markings 58 and 64 represent user selectable controls for selecting a number of 4.5×6 single image prints for each corresponding digital image. Here the user has indicated a desire for one 4.5×6 single image print for the digital images represented by thumbnails 38a and 38k.

With respect to FIGS. 3 and 4, the user's selection of the Wallet product control 40 followed by a selection of thumbnail 38a updated a list, often referred to as an electronic shopping cart, to include an order for a wallet print of the digital image represented by thumbnail 38a. The user's selection of the 8×10 product control 40 followed by a selection of thumbnail 38k updated the list to include an order for an 8×10 single image print of the digital image represented by thumbnail 38k. The user's selection of the 5×7 product control 40 followed by the selection of thumbnails 38a and 38d updated the list to include an order for a 5×7 single image print of the digital image represented by thumbnails 38a and 38d. The user's selection of the 4.5×6 product control 40a followed by the selection of thumbnails 38a and 38k updated the list to include an order for a one 4.5×6 single image print for each of the digital images represented by thumbnails 38a and 38k.

Assuming the user has finished selecting single image products, the user selects workflow control 42 stepping ahead to the next task in the workflow. Referring to FIG. 5, that next task is the selection of multi-image products and corresponding digital images for populating those products. The selection of workflow control 42 in FIG. 3 caused an update of workflow indicator 44 to indicate the current task 44b of selecting a multi-image product and digital images for populating the selected product. Replacing frame 36, user interface 34 now includes frame 66. Frame 66 includes thumbnails 38a-38l and product controls 68.

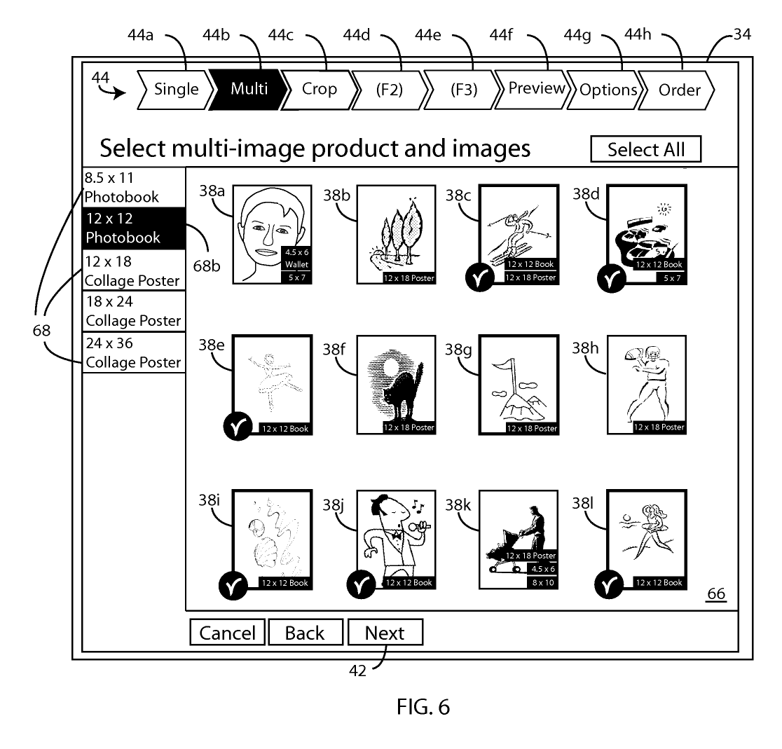

Product controls 68 allow a user to select from among a number of multi-image products. Here control 68a has been selected for a 12×18 collage poster. With control 68a selected, the user selects from among thumbnails 38a-38l to populate product a multi-image product. Here the user has selected thumbnails 38b, 38c, 38f, 38g, 38h, and 38k. The selection of product control 68a followed by the selection of thumbnails 38b, 38c, 38f, 38g, 38h, and 38k updated the list, discussed above, to include an order for a 12×18 collage poster populated with digital images corresponding to the selected thumbnails. Moving to FIG. 6, the user has selected product control 68b corresponding to a 12×12 photobook. To populate the photobook, the user has selected digital images represented by thumbnails 38c, 38d, 38e, 38i, 38j, and 38l. As a result, the list is updated to include an order for the photobook.

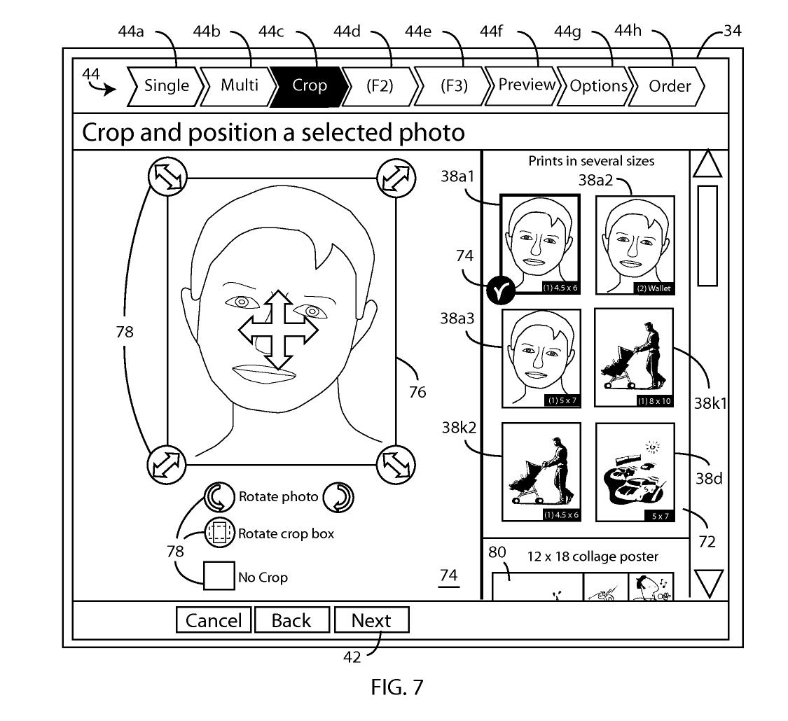

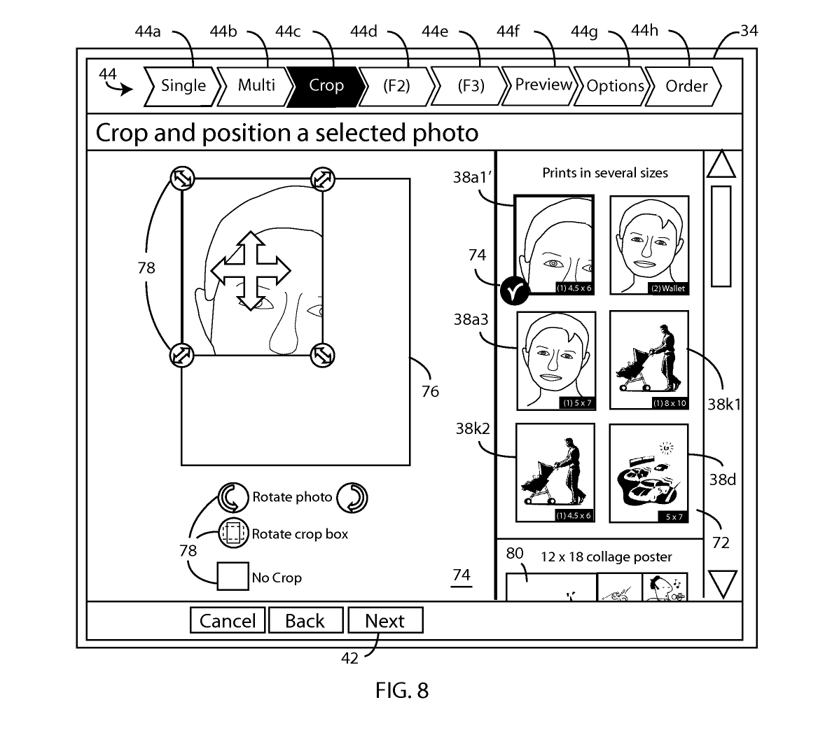

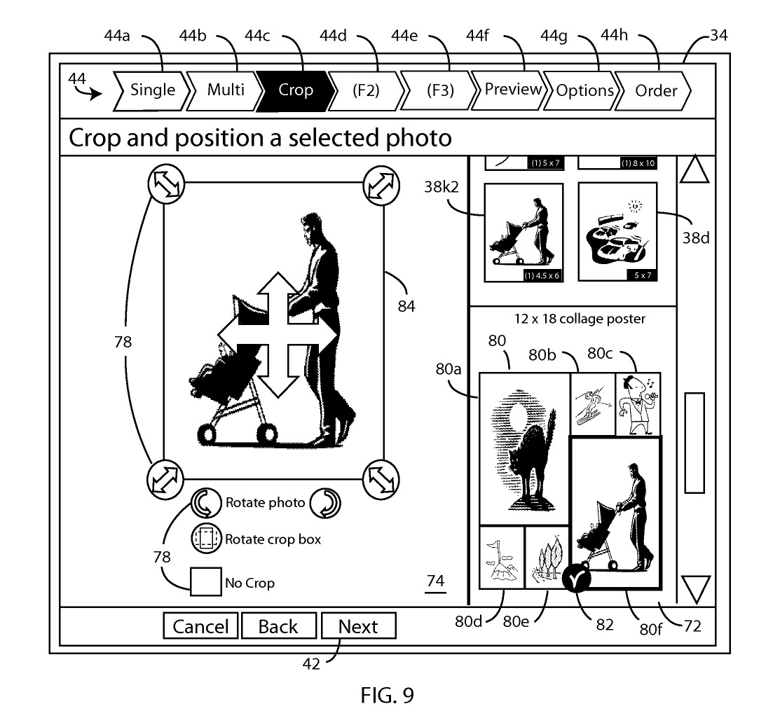

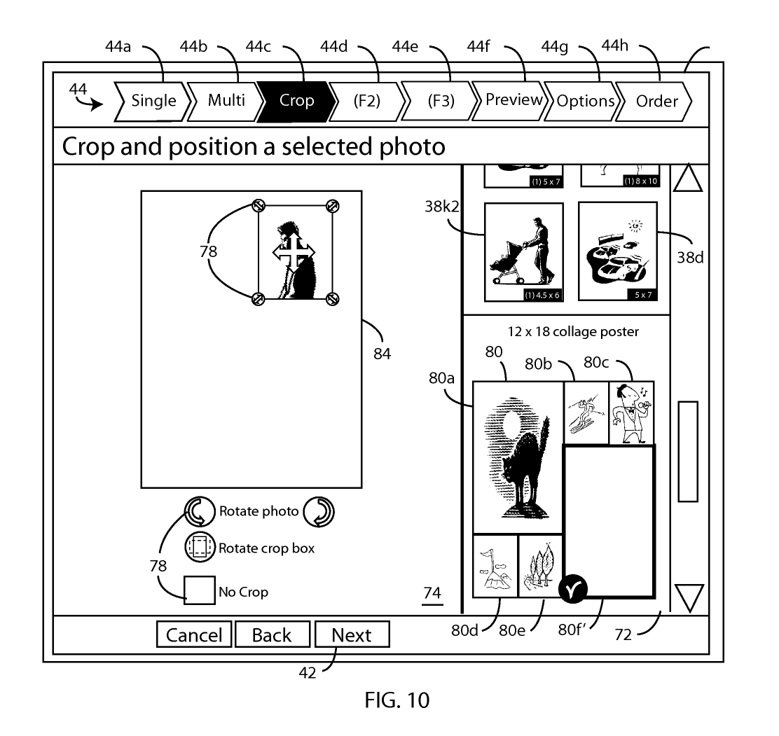

Assuming the user has finished selecting multi-image products, the user selects workflow control 42 stepping ahead to the next task 44c in the workflow. Referring to FIGS. 7-10, that next task involves providing an opportunity to edit each instance of a selected digital image used to populate a given product on the list. In the example of FIG. 7, editing includes cropping and positioning. Replacing frame 66, user interface 34 now includes frames 72 and 74. Frame 72 includes an individual thumbnail for each single image product included in the list (seen best in FIGS. 7 and 8) and a grouping of thumbnails for each multi-image product on the list (seen best in FIGS. 9 and 10). Frame 74 includes a product preview image corresponding to a thumbnail selected in frame 70. Referring to FIGS. 7 and 8, within frame 70, each individual thumbnail for a single-image product includes a representation of the digital image being used to populate that given single-image product. Referring to FIGS. 9 and 10, each grouping of thumbnails for a multi-image product includes individual thumbnails for each digital image used to populate that multi-image product.

In the example of FIG. 7, frame 72 includes thumbnails 38a, 38d1, 38d2, 38h, and 38k each corresponding to a single image product on the list as selected by the user in the previous workflow task 44a. While not completely visible, frame 70 also includes a grouping 80 of thumbnails corresponding to the multi-image product selected by the user in the previous workflow task 44b. Here, the user has selected thumbnail 38a as indicated by marking 74. As a result an editable product preview image 76 is displayed in frame 74.

Displayed with editable preview image 76 are controls 78 allowing the user to crop and position the digital image for a given single image product corresponding to the thumbnail 38a selected in frame 72. Referring to FIG. 8, once the user has cropped and positioned the digital image via the editable preview image 76, the single image product is modified accordingly. The corresponding thumbnail 38a′ in frame 72 is modified to provide an accurate preview of the modified single image product.

Moving to FIG. 9, the user has scrolled frame 72 to reveal grouping 80 of thumbnails corresponding to the collage poster selected in workflow task 44b. Grouping 80 includes individually selectable thumbnails 80a-80f each corresponding to digital image selected by the user to populate the collage poster. In the example of FIG. 9, the user has selected thumbnail 80a from grouping 80 as indicated by marking 82. As a result, editable preview image 84 is displayed in frame 74. Referring to FIG. 10, once the user has cropped and positioned the digital image via the editable preview image 84, the multi-image product is modified accordingly. The corresponding thumbnail 80a within grouping 80 in frame 70 is modified to provide an accurate preview of the modified multi-image product.

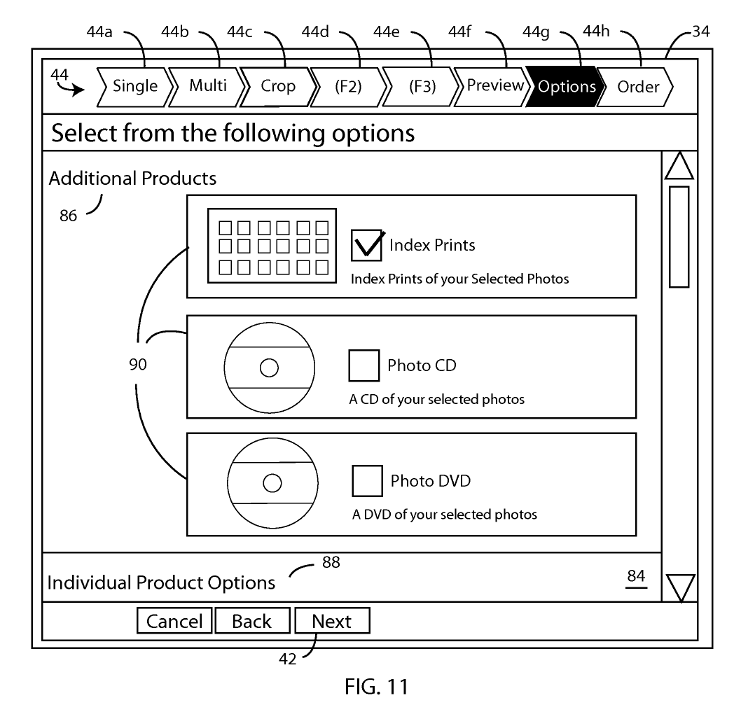

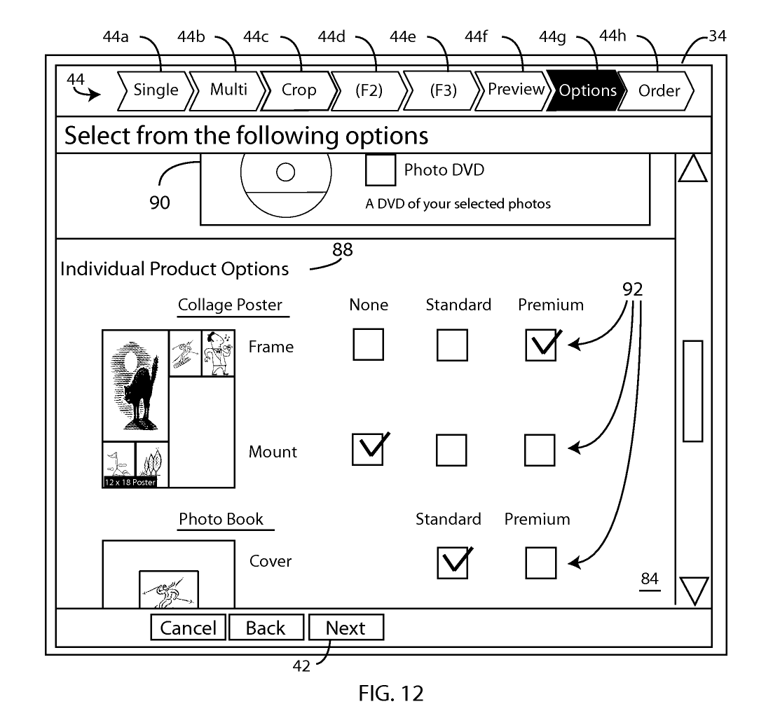

Via the workflow discussed with respect to FIGS. 3-10, a user has selected twelve digital images represented by thumbnails 38a through 38l to populate eight different products—six single image products and two multi-image products. Referring to FIGS. 11-12, the user selects workflow control 42 skipping ahead to options task 44g in the workflow. The options task allows the user to choose from among product options applicable to the selected products. Certain product options are applicable one or more of the selected products. Other product options are applicable to individual products. User interface 34 now includes frame 84, replacing frames 72 and 74. In the example of FIGS. 11 and 12, frame 84 is shown to include additional products section 86 (seen best in FIG. 11) and individual product options section 88 (seen best in FIG. 12). Section 86 includes option selectors 90, while section 88 includes option selectors 92. An option selector is an image or combination of images that when displayed identifies a particular product option and includes a control for choosing that option. Option selectors 90 are each applicable to one or more products, while each option selector 92 is applicable to an individual product.

Referring first to FIG. 11, option selectors 90 of section 86 identify and include controls for choosing from among three product options each corresponding to an additional product related to one or more of the selected products. In this example, those product options include additional products such as index prints, a photo CD, and a photo DVD. The user has selected the index prints option selector 90 applicable to all single image products selected by the user. As a result the list is updated to identify an additional product—the chosen index prints.

Referring to FIG. 12, the user has scrolled frame 84 to more fully reveal section 88. Option selectors 92 of section 88 identify and includes controls for choosing from among product options applicable to individual products. Each option selector 92 also identifies the particular product to which it applies. Those products here are the selected collage poster and photobook. Two option selectors 92 for framing and mounting are applicable individually to the collage poster. One option selector 92 for cover selection is applicable to the photobook. The user has chosen a premium frame for the collage poster and a standard cover for the photobook. As a result the list is updated such that the collage poster includes the premium frame and the photobook includes a standard cover.

Via the exemplary user interface 34 of FIGS. 3-13 a user is able to manage and order single and multi image products in a single workflow. Within that workflow, the user can select a desired digital image or images for populating each product being ordered. The user can also edit each instance of a digital image selected to populate a given product. Finally, the user is able to choose from among production options applicable to the selected products.

### Components

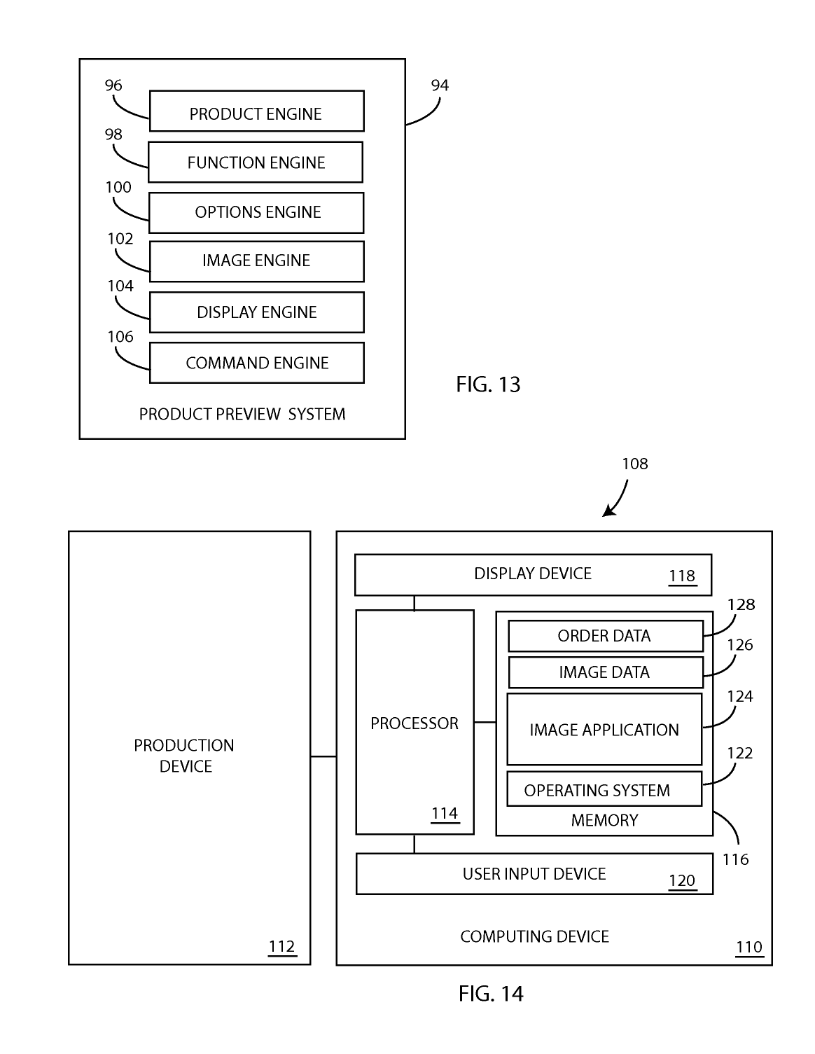

FIG. 13 depicts various physical and logical components that function as product preview system 94. System 94 is shown to include product engine 96, function engine 98, options engine 100, image engine 102, display engine 104, and command engine 106. Product engine 96 represents generally any combination of hardware and programming for defining the single and multi-image products available for ordering. Definitions for the single image products can define print sizes and the available media on which the digital images can be formed. Such media can include photo paper, coffee mugs, clothing, and the like. Thus, one single image product may include an eight by ten image formed on photo paper. Another single image product may be defined as four by four image formed on a mouse pad.

Function engine 98 represents generally any combination of hardware and programming configured to define one or more functions for editing digital images selected to populate a product or products. Such functions can include cropping, positioning, color management, red-eye removal, adding borders, and the like.

Options engine 100 represents generally any combination of hardware and programming configured to define production options available for a list of selected products. A product option can be an additional product related to one or more of a set of selected products. Index prints and photo CDs for single image products are examples. A product option can also relate to an addition to or configuration of a selected product. Frames for posters and cover material for photobooks are examples. In performing its function, option engine 100 examines a list of products selected by a user and identifies only those product options that are applicable to the selected products.

Image engine 102 represents generally any combination of hardware and programming configured to generate and modify objects to be displayed as part of a user interface. In particular, image engine 102 is responsible for generating thumbnails from a set of digital images. Image engine 102 is also responsible for generating and modifying thumbnails to be displayed in various frames of a user interface. Initially, image engine 102 is responsible for generating a first set of thumbnails for each of a set of digital images available to a user. Upon selection of a thumbnail from the first set, image engine 102 is responsible for modifying that thumbnail to indicate its selection for populating a give product with a corresponding digital image. FIGS. 3-5, discussed above, provide examples.

Image engine 102 is responsible for generating a second set of thumbnails. The second set includes a thumbnail for each instance of a digital image selected to populate a single image product and groupings of thumbnails for digital images selected to populate one or more multi-image products. Upon selection of a thumbnail from the second set, image engine 102 is responsible generating a corresponding editable preview image. Image engine 102 modifies a thumbnail selected from the second set to reflect the manner in which the editable preview image has been manipulated by a user. FIGS. 6-9, discussed above, provide examples.

Image engine 102 is responsible for generating option selectors for a set of selected single and multi-image products. An option selector is an image or collection of images that when displayed identify a particular product option and include a control or controls for choosing the option with respect to a set of products or with respect to an individual product as the case may be. A given option selector may also identify the product or products to which it is applicable. In performing this task, image engine 102 communicates with options engine 100 to identify those options that are applicable to the selected products. For each identified option that is applicable to multiple products, image engine 102 generates a single option selector for use with respect to those multiple products. Examples include an option selector for choosing index prints and an option selector choosing a photo CD for a set of single image products. For each identified option that is applicable to an individual product, image engine 102 generates an option selector for use with respect to that individual product. Examples include an option selector related to framing choices for a particular poster and an option selector related to cover choices for a photo book.

Display engine 104 represents generally any combination of hardware and programming configured to cause, in accordance with a current workflow task, the display of objects generated and modified by image engine 102. Such objects include thumbnails, preview groups, and enlarged preview images. Display engine 104 is also responsible for causing the display of various controls including product selection controls, workflow controls, image selection controls, and option selectors as indicated by the current workflow task. FIGS. 3-12, discussed above, provide examples.

Command engine 106 represents generally any combination of hardware and programming configured to detect a user's selections from among the objects caused to be displayed by display engine 104. From the user's selections, command engine 106 generates a list identifying single and multi-image products selected by a user. In a given example, command engine 106 identifies a user's selections from among various option selectors caused to be displayed during an options task of a workflow and updates the list accordingly.

System 94 of FIG. 13 may be implemented in a number of environments such as environment 108 of FIG. 14. Environment 108 includes computing device 110 and production device 112. Computing device 110 may be a general purpose computer, a specialized kiosk, or an integrated sub-system of production device 112. Production device 112 represents generally any device or collection of devices capable of producing single and multi-image products ordered via computing device 110.

Computing device 110 is shown to include processor 114, memory 116, display device 118, and user input device 120. Processor 114 represents generally any device capable of executing program instructions stored in memory 116. Memory 116 represents generally any memory configured to store program instructions and other data. Display device 118 represents generally any display device capable of displaying a graphical user interface at the direction of processor 114. User input device 120 represents generally any device such as a mouse, keyboard, or a touch screen through which a user can interact with a user interface presented via display device 118.

Memory 116 is shown to include operating system 122, image application 124, image data 126, and order data 128. Operating system 122 represents generally any software platform on top of which other programs or applications such as image application 124 run. Examples include Linux® and Microsoft Windows®. In this example, operating system 122 includes drivers for controlling the operation of components 118 and 120. In particular, these drivers translate generic commands into device specific commands capable of being utilized by components 118 and 120.

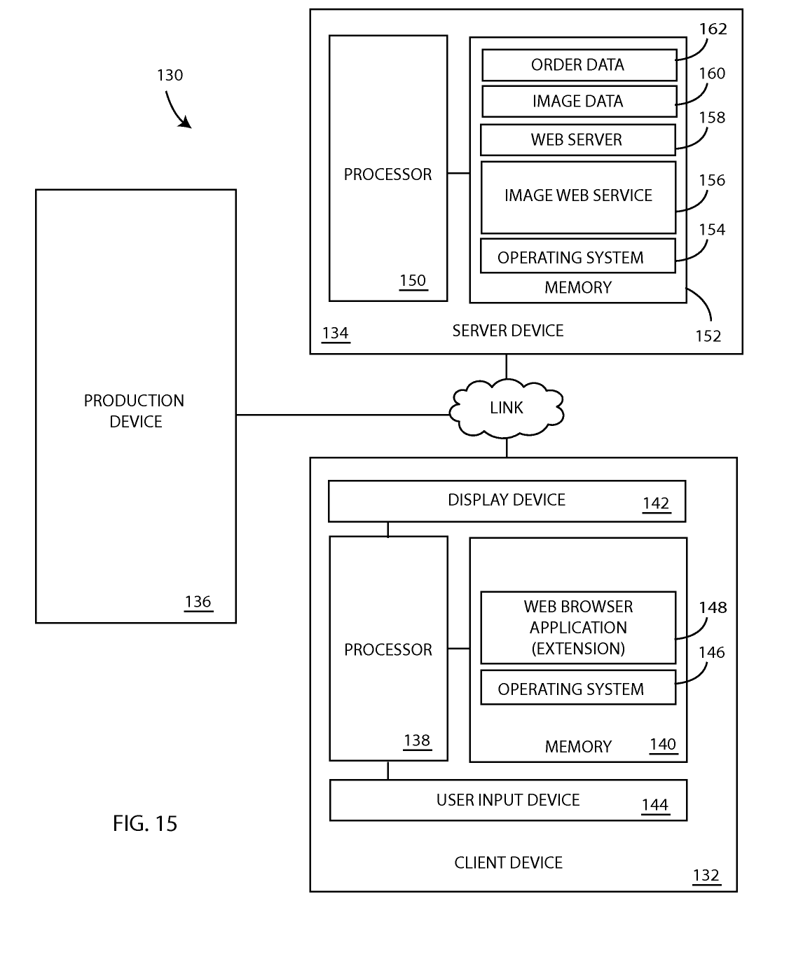

Image application 124 represents generally any programming that, when executed, implements the functionality of engines 96-106 of FIG. 13. Image data 126 represents the digital images image application 124 acts upon. Order data 128 represents data identifying single and multi image products ordered by a user. As noted above, the various components of system 94 of FIG. 13 include combinations of hardware and programming. With respect to FIG. 15, the hardware components may be implemented though processor 114. The programming elements may be implemented via image application 124. In particular, the workflow for selecting, editing, and previewing single and multi-image products may be presented via a user interface generated and managed by image application 124.

System 94 of FIG. 13 may be implemented in environment 130 of FIG. 15. Environment 130 includes client device 132, server device 134, and production device 136. Client device 132 may be a general purpose computer, a specialized kiosk, or an integrated sub-system of production device 136. Server device 134 represents any computing device capable of serving content. Production device 136 represents generally any device or collection of devices capable of producing single and multi-image products ordered via client device 132 and server device 134.

Client device 132 is shown to include processor 138, memory 140, display device 142, and user input device 144. Processor 138 represents generally any device capable of executing program instructions stored in memory 140. Memory 140 represents generally any memory configured to store program instructions and other data. Display device 142 represents generally any display device capable of displaying a graphical user interface at the direction of processor 138. User input device 144 represents generally any device such as a mouse, keyboard, or a touch screen through which a user can interact with a user interface presented via display device 118.

Memory 140 is shown to include operating system 146 and web browser application 148. Operating system 146 represents generally any software platform on top of which other programs or applications such as web browser application 148 run. Examples include Linux® and Microsoft Windows®. In this example, operating system 146 includes drivers for controlling the operation of components 142 and 144. In particular, these drivers translate generic commands into device specific commands capable of being utilized by components 142 and 144. Web browser application 148 represents generally any programming that, when executed by processor 138, requests and causes a display of content served by server device 134. Web browser application 124 is also responsible for communicating data indicative of user input back to server device 134.

Server device 134 is shown to include processor 150 and memory 152. Processor 150 represents generally any device capable of executing program instructions stored in memory 152. Memory 152 represents generally any memory configured to store program instructions and other data. Memory 152 is shown to include operating system 154, image web service 156, web server 158, image data 160, and order data 162. Operating system 154 represents generally any software platform on top of which other programs or applications such as service 156 and server 158 run. Examples include Linux® and Microsoft Windows®.

Image web service 156 in combination with web server 158 represents generally any programming that, when executed, implements the functionality of engines 96-106 of FIG. 13. Image data 160 represents the digital images image web service 156 acts upon. Order data 162 represents data identifying single and multi image products ordered by a user and indicated by communications received by web server 158 from client device 132.

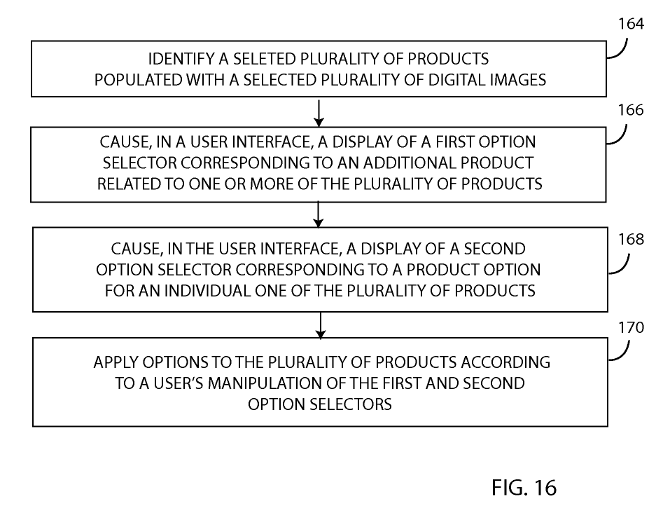

As noted above, the various components of system 94 of FIG. 13 include combinations of hardware and programming. With respect to FIG. 16, the hardware components may be implemented though processor 150. The programming elements may be implemented via image web service 156 and web server 158. In particular the workflow for selecting and editing single and multi-image products may be presented and managed via content generated by image web service 156 and served by web server 158.

### Operation

FIG. 16 is an exemplary flow diagram of steps taken to implement an embodiment providing a common workflow for selecting and editing single and multi image products. In discussing FIG. 16, reference may be made to the diagrams of FIGS. 1-15 to provide contextual examples. Implementation, however, is not limited to those examples.

Initially, a selected plurality of products is identified (step 164). The plurality of products are populated with a selected plurality of digital images. A first object selector is caused to be displayed (step 166). The first object selector is corresponds to an additional product related to one or more of the plurality of products. A second object selector is caused to be displayed (step 168). The second object selector is corresponds to a product option for an individual one of the plurality of products. Options are applied to the plurality of products according to a user's manipulation of the first and second option selectors (step 170).

Referring to FIG. 13, display engine 104 may be responsible for implementing steps 166 and 168 while command engine 106 may be responsible for implementing steps 164 and 170. FIGS. 11 and 12 depict an exemplary user interface displaying option selectors 90 and 92. Each option selector 90 may be considered a first option selector applicable to two or more of a plurality of products. Each option selector 92 may be considered a second option selector applicable only to an individual one of a plurality of products.

Following detection of a user's manipulation of the first option selector, a first option is applied in step 170 to the two or more of the plurality of products. Such may include adding an additional product to the plurality of products. An additional product, in the example of FIG. 11, can include index prints, a photo CD, or a photo DVD. Of course, other additional products that each correspond to two or more of a plurality of products are contemplated.

Following detection of a user's manipulation of the second option selector, a second option is applied in step 170 to only the individual one of the plurality of products. Such may include updating the individual one of the plurality of products. An update, in the example of FIG. 12, can include adding a particular frame or mount to a poster or selecting a particular cover for a photobook. Of course, other updates that correspond to only an individual one of a plurality of products are contemplated.

The method depicted in FIG. 16 may also include identifying only those product options that are applicable to the plurality of products identified in step 164. The identified product options include a first product option and a second product option. The first product selector is generated for that first product option, and the second product selector is generated for the second product option. Referring again to FIG. 13, option engine 100 may be responsible for identifying the product options. Image engine 102 may be responsible for generating the first and second option selectors. Image engine 102 may generate the first option selector such that when displayed it identifies a first option and includes a control for selecting the first option. Option selectors 90 of FIG. 11 provide an example. Image engine 102 may generate the second option selector such that when displayed it identifies a second option, includes a control for selecting the first option, and identifies the individual one of the plurality of products to which it applies. Option selectors 92 of FIG. 12 provide an example.

### CONCLUSION

The diagrams of FIGS. 1-12 are used to depict exemplary environments, components, and user interface displays. Implementation, however, is not so limited. FIGS. 13-15 show the architecture, functionality, and operation of various embodiments. Various components illustrated in FIGS. 13-15 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as; for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 16 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A product option selection method for a plurality of selected products populated with a selected plurality of digital images, the method comprising:
causing, in a frame of a user interface, a display of a first option selector and a second option selector, the first option selector corresponding to an additional product related to one or more of the plurality of products, the second option selector being corresponding to a product option for an individual one of the plurality of products; and
applying options to the plurality of products according to a user's manipulation of the first and second option selectors.

2. The method of claim 1, wherein applying comprises:
following detection of a user's manipulation of the first option sector, applying a first corresponding to the one or more of the plurality of products; and
following detection of the user's manipulation of the second option selector, applying a second option to the individual one of the plurality of products.

3. The method of claim 2, wherein
applying a first option to the two or more of the plurality of products comprises adding a product to the plurality of products that corresponds to the one or more of the plurality of products, the added product corresponding to the user's manipulation of the first option selector; and
applying a second option to the individual one of the plurality of products comprises updating the individual one of the plurality of products according to the user's manipulation of the second option selector.

4. The method of claim 2, wherein;
the first option selector, when displayed identifies a first option and includes a control for selecting the first option; and
the second option selector, when displayed identifies a second option and includes a control for selecting the second option.

5. The method of claim 4, wherein the second option selector, when displayed, identifies the individual product to which it applies.

6. The method of claim 1, further comprising:
from a plurality of available product options, identifying only those product options applicable to the plurality of selected products, the identified product options including a first product option and a second product option; and
generating the first option selector for the first product option and generating the second product selector for the second product option.

7. A computer readable medium storing computer executable instructions that when executed implement a product option selection method for a plurality of selected products populated with a selected plurality of digital images, the method comprising:
causing, in a frame of a user interface, a display of a first option selector and a second option selector, the first option selector corresponding to an additional product related to one or more of the plurality of products, the second option selector being corresponding to a product option for an individual one of the plurality of products; and
applying options to the plurality of products according to a user's manipulation of the first and second option selectors.

8. The medium of claim 7, wherein applying comprises:
following detection of a user's manipulation of the first option sector, applying a first corresponding to the one or more of the plurality of products; and
following detection of the user's manipulation of the second option selector, applying a second option to the individual one of the plurality of products.

9. The medium of claim 8, wherein
applying a first option to the two or more of the plurality of products comprises adding a product to the plurality of products that corresponds to the one or more of the plurality of products, the added product corresponding to the users manipulation of the first option selector; and
applying a second option to the individual one of the plurality of products comprises updating the individual one of the plurality of products according to the user's manipulation of the second option selector.

10. The medium of claim 8, wherein;
the first option selector, when displayed identifies a first option and includes a control for selecting the first option; and
the second option selector, when displayed identifies a second option and includes a control for selecting the second option.

11. The medium of claim 10, wherein the second option selector, when displayed identifies the individual product to which it applies.

12. The medium of claim 7, further comprising:
from a plurality of available product options, identifying only those product options applicable to the plurality of selected products, the identified product options including a first product option and a second product option; and
generating the first option selector for the first product option and generating the second product selector for the second product option.

13. A system for selecting product options for a selected plurality of products populated with a selected plurality of digital images, comprising a display engine and a command engine, wherein:
the display engine is operable to cause, in a frame of a user interface, a display of a first option selector and a second option selector, the first option selector corresponding to an additional product related to one or more of the plurality of products, the second option selector being corresponding to a product option for an individual one of the plurality of products; and
the command engine is operable to apply options to the plurality of products according to a user's manipulation of the first and second option selectors.

14. The system of claim 13, wherein the command engine is operable to:
detect a user's manipulation of the first and second option selectors;
apply a first option corresponding to the one or more of the plurality of products following detection of a user's manipulation of the first option sector; and
apply a second option to the individual one of the plurality of products following detection of the user's manipulation of the second option selector.

15. The system of claim 14, wherein the command engine is operable to:
add a product to the plurality of products, the added product corresponding to the user's manipulation of the first option selector; and
update the individual one of the plurality of products according to the user's manipulation of the second option selector.

16. The system of claim 14, wherein;
the first option selector, when displayed identifies a first option and includes a control for selecting the first option; and
the second option selector, when displayed identifies a second option and includes a control for selecting the second option.

17. The system of claim 16, wherein the second option selector, when displayed identifies the individual product to which it applies.

18. The system of claim 13, further comprising:
an option engine operable to identify, from a plurality of available product options, only those product options applicable to the plurality of selected products, the identified product options including a first product option and a second product option; and
an image engine operable to generate the first option selector for the first product option and generate the second product selector for the second product option.
